(19) United States
(12) Patent Application Publication
(10) Pub. No.: US 2004/0145647 A1
(43) Pub. Date: Jul. 29, 2004

(54) Nonlinear transformation of pixel width

(76) Inventor: Robert D. Morrison, Star, ID (US)

Correspondence Address: HEWLETT-PACKARD COMPANY, Intellectual Property Administration, P.O. Box 272400, Fort Collins, CO, 80527-2400, US

(21) Appl. No.: 10/350,401

(22) Filed: Jan. 23, 2003

(51) Int. Cl. B41J 2/435

(52) U.S. Cl. 347/247; 347/249

(57) ABSTRACT

Print data is resolved into pixels that each include a corresponding placement parameter. A nonlinear transfer function is applied to a width parameter for each pixel, and data is generated based on transformed width parameters and the corresponding placement parameters.

### BACKGROUND

Electrophotographic imaging devices, such as laser printers, scanners, copiers, and fax machines may use a scanning device to form latent electrostatic images on a photoconductor. In a laser printer, for example, imaging data may be used to selectively expose areas of a rotating photoconductive drum to a beam of light from a laser diode that is swept across (i.e., horizontally) the surface of the drum by the scanning device. Images are quantized into small regions called pixels, and more and more pixel information is deposited on the drum to form the latent image with each sweep of the laser beam across the surface of the photoconductive drum. In general, image quality improves as the quantized area for pixels decreases in the direction the beam is swept across the surface of the photoconductor (i.e., horizontally). The minimum horizontal quantization size can be decreased by decreasing the minimum time period that the laser diode can be turned on during a sweep across the surface of the photoconductor.

A visible image is developed on the drum using one or more types of electrostatic toner. For black and white printing, a single, black toner is used. For color printing, multiple different color toners are used. Each toner is selectively attracted onto the photoconductive surface of the drum that is either exposed or unexposed to light, depending on the relative electrostatic charges on the photoconductive surface, characteristics of the development toner, and the type of toner used. A charged transfer roller may be used to pull the toner from the photoconductive surface, transferring the developed image onto an appropriate recording media, such as paper or transparencies.

Although image quality is improved by decreasing the quantized area for pixels, additional benefits are also derived by an ability to develop finite portions within quantized pixel areas. Benefits include increasing the number of colors and shades of gray from those that are otherwise available from the quantized pixel. Pulse width modulation (PWM) may be used for developing only a portion of a pixel region. By modulating the laser beam via a pulse width modulator (PWM), variations in electrostatic charge on the photoconductive drum result in proportionate amounts of toner being deposited onto a sheet of paper. Thus, the benefit of finer colors and shades of gray is realized.

A PWM technique is described in U.S. Pat. No. 6,366,307, entitled “CLOCK INDEPENDENT PULSE WIDTH MODULATION” and incorporated herein by reference. Another PWM technique is described in U.S. Pat. No. 6,373,515, entitled “VARIABLE RESOLUTION TRANSITION PLACEMENT DEVICE” and incorporated herein by reference.

Although there are various advantages to the nonlinear pulse width modulation (NLPWM) described in U.S. Pat. No. 6,373,515, problems persist regarding how to apply transfer functions in a manner that reduces the likelihood of printing artifacts or periodic patterns resonant within the pixel frequency in the output image.

### SUMMARY

Print data is resolved into pixels that each include a corresponding placement parameter. A nonlinear transfer function is applied to a width parameter for each pixel, and data is generated based on transformed width parameters and the corresponding placement parameters.

### BRIEF DESCRIPTION OF THE DRAWINGS

The same reference numbers are used throughout the drawings to reference like components and features.

FIG. 1 illustrates an exemplary environment for implementing one or more embodiments of an imaging device that provides nonlinear pixel modulation.

FIG. 2 is a block diagram representation of an embodiment of an electrophotographic imaging device including an embodiment of a formatter and an embodiment of a photoconductor exposure system.

FIG. 3 is a block diagram representation of an embodiment of an electrophotographic imaging device including an embodiment of control circuitry and an embodiment of a photoconductor exposure system.

FIG. 4 is a flow diagram illustrating an example method for using an embodiment of an electrophotographic imaging device that provides nonlinear pixel modulation.

### DETAILED DESCRIPTION

Overview

The following discussion is directed to systems and methods that enable the generation of nonlinear laser modulation from a pulse width modulator that reduces unwanted artifacts in printed image output.

Methods for applying transfer functions to pixelized print data include a mathematically precise method and a linear interpolation method. The mathematically precise method of applying transfer functions could be prohibitively complex and expensive to implement. Such a method could involve developing hardware to solve differential equations for determining the exact locations for placing edges of pixels. The number of logic gates used to implement this method might make most laser printers and other related imaging devices too expensive for the average consumer. In addition, pulse width modulation (PWM) hardware may not be configured to accept print data in the form of pixel edges. Therefore, a method that involves sending edge locations to the PWM circuit could involve a significant redesign of PWM hardware.

The linear interpolation method of applying transfer functions involves sampling pixel frequency at each pixel and interpolating the subpixel modulation point used for that pixel. This method may be more cost effective than a mathematically precise method and also conforms to the data requirements of PWM hardware whereby subpixel modulations are encoded into four categories: center-justified, right-justified, left-justified, an inverted center-justified. However, such a method may introduce distortions of the pixel frequency into the laser modulation output, thereby causing visual aberrations in the printed image. The reason for this is that subpixel modulation includes an assertion edge and a deassertion edge. For continuously varying (i.e. nonlinear) functions and discrete functions, edge locations within a pixel submodulation vary according to the transfer function just like the boundaries of the pixels themselves. The linear interpolation method may cause incorrect subpixel assertion time which may result in shades of gray that are substantially different than the intended shade. This in turn, may result in shading artifacts that are readily discernible by visual inspection.

Various nonlinear transfer functions may be applied to pixelized print data through an algorithm that computes a transformed width of the pixel data based on a nonlinear transfer function. Computing a transformed subpixel width rather than an absolute subpixel position reduces the complexity of computations, while placement of subpixels within nonlinear pixel boundaries based on current subpixel encoding schemes accommodates available electrophotographic imaging hardware without a need to redesign conventional PWM hardware.

Exemplary Environment

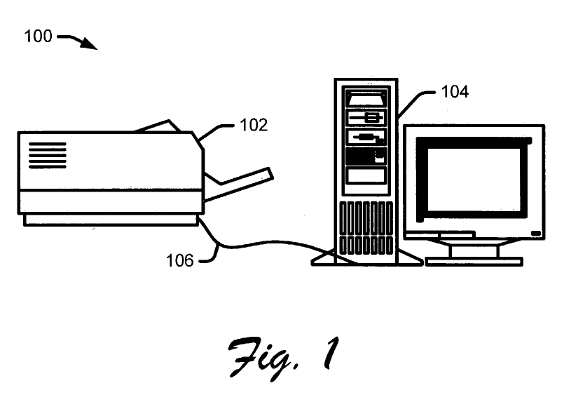

FIG. 1 illustrates an exemplary environment for implementing one or more embodiments of an imaging device that provides nonlinear pixel modulation. The environment 100 of FIG. 1 includes imaging device 102 operatively coupled to a host computer 104 through a direct or network connection 106. The direct or network connection 106 can include, for example, a printer cable, a LAN (local area networks), a WAN (wide area networks), an intranet, the Internet, or any other suitable communication link. Connection 106 can also include a wireless communications link such as an IR (infrared) or RF (radio frequency) link.

This disclosure is applicable to various types of imaging devices capable of implementing an electrophotographic process such as an electrophotographic printing (EP) process for rendering PDL (page description language) data in printed form on a print medium. Therefore, printing device 102 can include devices such as laser-based printers, photocopiers, scanners, fax machines, multifunction peripheral devices and other EP-capable devices.

Host computer 104 can be implemented as a variety of general purpose computing devices including, for example, a personal computer (PC), a server, a Web server, and other devices configured to communicate with imaging device 102. Host computer 104 typically provides a user with the ability to manipulate or otherwise prepare in electronic form, an image or document to be rendered as an image that is printed or otherwise formed onto a print medium by imaging device 102 after transmission over network 106. In general, host computer 104 outputs host data to imaging device 102 in a driver format suitable for the device 102, such as PCL or PostScript. Imaging device 102 converts the host data and outputs it onto an appropriate recording media, such as paper or transparencies.

Exemplary Embodiments

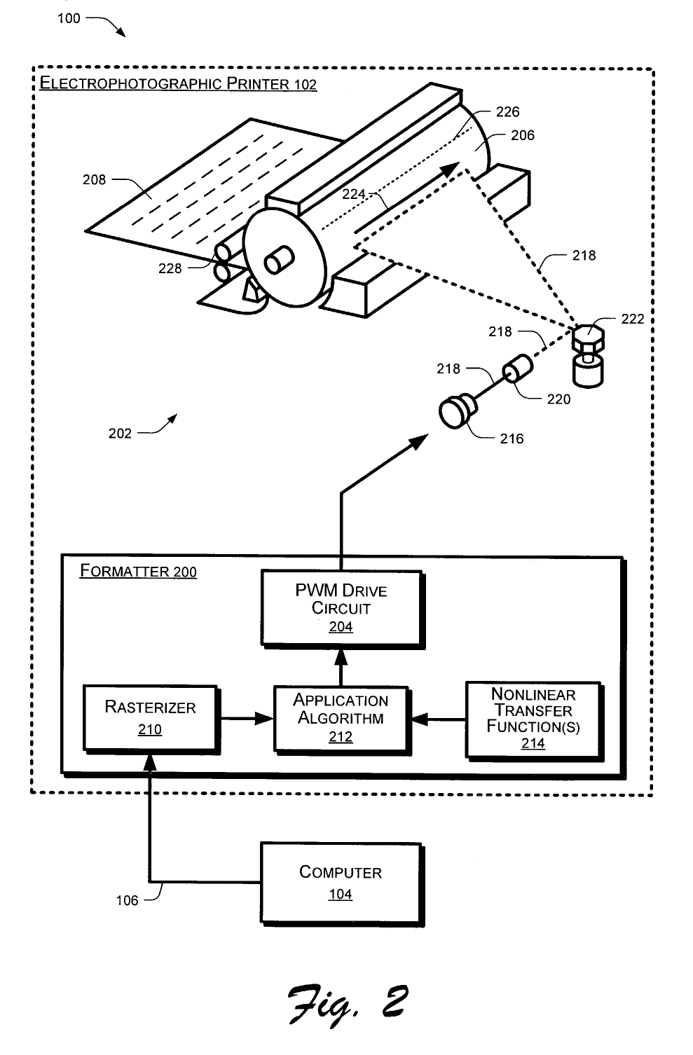

FIG. 2 is a block diagram representation of an electrophotographic imaging device embodied as an electrophotographic/laser printer 102. The block diagram representation of electrophotographic/laser printer 102 includes an embodiment of an image data formatter 200 and an embodiment of an image forming system 202. Computer 104 provides data, including print data, to formatter 200. Electrophotographic printer 102 of FIG. 2 is generally disposed to modulating the operating frequencies of a pulse width modulator (PWM) 204 to place pixels onto the surface of a photoconductive element 206 for holding an image to be printed onto a print medium such as paper 208.

Data formatter 200 is typically embodied as an ASIC (application specific integrated circuit) having various blocks of hardware implemented as logic gates. Thus, data formatter 200 includes a rasterizer block 210, an application algorithm block 212, a block for implementing one or more nonlinear transfer functions 214, and a PWM (pulse width modulation) circuit block 204. Formatter 200 is generally part of a larger printed circuit assembly (not shown) that includes, for example, a memory such as Random Access Memory (RAM) for holding an image to be printed, a microprocessor for processing the image to be printed, and other general circuitry. Details of such additional peripheral circuitry are not included in FIG. 2 but are incorporated herein.

Application algorithm 212 in formatter 200 generates a stream of video data that is supplied to PWM driver circuit 204. PWM driver circuit 204 receives the video data and controls the flow of drive current to image forming system 202. More specifically, PWM driver circuit 204 provides drive current to a light source, such as laser diode 216. In response to the drive current, laser diode 216 generates a pulsating beam 218. The time period of the pulses of the beam correspond to the time period of the pulses of the video data. Image forming system 202 controls the movement of pulsating beam 218 from laser diode 216 across the surface of photoconductive element 206. Pulsating beam 218 passes through collimating lens 220, is reflected from rotating scanning mirror 222, and impinges upon photoconductive element 206. Pulsating beam 218 exposes regions on the surface of photoconductive element 206 that have a dimension (in the direction 224 pulsating beam 218 moves across the surface of photoconductive element 206) corresponding to time periods of the pulses of the video data. Exposed regions have a different electrostatic charge than unexposed regions. The electrostatic charge differential forms a latent image and permits development of toner to the photoconductive element 206 in a pattern corresponding to the latent image. Transfer roller 228 facilitates the transfer of toner from photoconductive element 206 onto a print medium 208 in the form of a visible image.

Although FIG. 2 illustrates photoconductive element 206 in the form of a photoconductive drum 206, it is understood that other forms of photoconductive elements 206 are possible. For example, photoconductive element 206 can optionally be configured as a continuous, photoconductive belt (not shown) or other transfer medium whether photoconductive or not.

Referring again to the data formatter 200 of FIG. 2, rasterizer 210 converts the print data from computer 104 into pixel data used to form an image on print media 208. One encoding scheme used in formatter 200 involves encoding pixels within the pixel data into one of four categories: center justified; right justified; left justified; and inverted center justified. The four categories are parameters that indicate how a subpixel modulation is to be placed within pixel boundaries. Rasterizer 210 may include dedicated hardware for generating the pixel data or it may include a processor executing firmware to generate the data as discussed in a subsequent embodiment.

Nonlinear transfer function(s) 214 can change depending upon the desired transfer function over a scan line (e.g., 226) of pixel data. A transfer function 214 may be selected to generate a relatively smooth variation in resolution across the scan line 226 that compensates for the variable sweep rate of pulsating beam 218 across photoconductive element 206 resulting from the absence of a flat focusing lens. Alternatively, a transfer function 214 could be selected to generate a step change in resolution across the scan line 226 that could, for example, be used to print pictures at one resolution and text at another resolution. Or, a transfer function 214 could be selected to scale an image so that an image having a lower resolution (generated by scanning a unit of media) than the nominal resolution of the imaging device would be generated at the same size as in the unit of media upon which printing was performed. Or, a transfer function 214 could be selected to generate a substantially constant resolution across the scan line 226. In addition, a transfer function 214 could be selected to achieve an arbitrary resolution versus displacement function over the scan line 226.

It is noted that the transfer function 214 is not limited to a smoothly varying transfer function but can be any analytic transfer function. Even discretely varying functions have special utility in imaging devices.

Application algorithm 212 provides a technique for applying a transfer function 214 to pixelized data from rasterizer 210 that results in a reduction of artifacts in the printed image output. While a mathematically precise method of applying a transfer function 214 would prevent unwanted artifacts from appearing in printed image output, such a method may be prohibitively complex and expensive to implement as discussed above. Determining the exact locations for placing edges of pixels is computationally complex and would make use of additional computation hardware and reconfiguration of PWM hardware in order to accept print data in the form of pixel edges.

Application algorithm 212 generally presumes that the precise placement of a subpixel modulation within nonlinear pixel boundaries is not as significant as the amount of toner that is expected to be developed to the subpixel modulation. Therefore, the application algorithm 212 computes transformed widths of the pixel data from rasterizer 210 based on a nonlinear transfer function 214. That is, the application algorithm 212 applies the nonlinear transfer function 214 to the width values of the pixel data. Thus, the nonlinear transfer function 214 computes the transformed widths of pixels rather than computing absolute positions based on computed edges.

Application algorithm 212 generates streams of video data based on the transformed pixel widths and the placement parameters (i.e., center justified; right justified; left justified; and inverted center justified) encoded into the pixel data from rasterizer 210. Because the transformed widths are computed as if the two subpixel edges were determined according to the nonlinear transfer function 214, unwanted artifacts due to errors in gray shading will be substantially reduced in the printed output image. However, because the encoded pixel types (i.e., center justified; right justified; left justified; and inverted center justified) are left intact (i.e., not transformed by nonlinear transfer function 214), there will be second order effects resulting from slightly incorrect placement of a center justified pixel next to a right justified pixel, for example. Nevertheless, since a substantially correct amount of toner will be deposited based on the nonlinearly transformed pixel widths, shades of gray in the printed output image will be substantially correct.

If the nonlinear transfer function 214 is not analytic (for example, a sudden step from one pixel resolution to another), the algorithm 212 will cause an artifact at the boundary of the step function or change. The weight of each resolution will then be included in the computation of where subpixel edges will be placed. Such an artifact at the boundary of the step function or change is acceptable for two reasons. First of all, sudden changes to the resolution for most printer documents will, in general, be executed on pixel boundaries (which will not cause an artifact problem). In addition, sudden changes in resolution will normally be done at the boundaries of an image, where the eye will be expecting a major change in the image anyway. Thus, attempting to compensate correctly across step transfer function boundaries is believed to be unnecessary, and the algorithm 212 width method of applying a nonlinear transform 214 to subpixel modulation significantly reduces unwanted artifacts without including extensive computing overhead or hardware redesign.

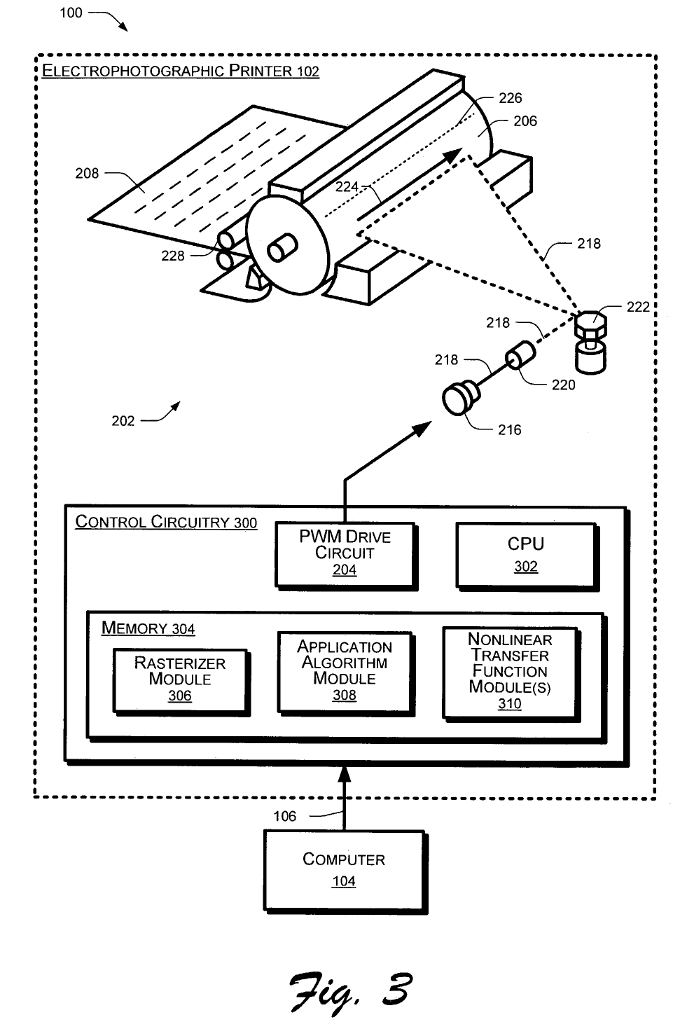

FIG. 3 is another block diagram representation of an electrophotographic imaging device embodied as an electrophotographic/laser printer 102. The block diagram representation of electrophotographic/laser printer 102 includes an embodiment of control circuitry 300 and an embodiment of a photoconductor exposure system 202.

The electrophotographic printer 102 of FIG. 3 is configured in and functions in substantially the same way as the electrophotographic printer 102 of FIG. 2 discussed above. Thus, image forming system 202 is configured to receive drive current from PWM driver circuit 204 and generate a visible image on a print medium 208 in the same manner as described above with respect to the embodiment of FIG. 2.

Control circuitry 300 of FIG. 3 is configured to perform the same data formatting functions as described above regarding data formatter 200 of FIG. 2. However, in the FIG. 3 embodiment, data formatting functions are performed by computer/processor-readable instructions executing on a processor. Therefore, the control circuitry 300 of FIG. 3 includes a processor 302 and a memory 304 (e.g., ROM, hard disk, floppy disk, CD-ROM, etc.). Memory 304 generally provides storage of computer/processor-readable instructions, data structures, program modules and other data for electrophotographic printer 102. Accordingly, memory 304 includes software modules that parallel the hardware blocks of formatter 200 (FIG. 2).

A rasterizer module 306 is executable on processor 302 to convert print data from computer 104 into pixel data used to form an image on print media 208. As discussed above, pixels within the pixel data are encoded into one of four placement categories (center justified; right justified; left justified; and inverted center justified) indicating how a subpixel modulation is to be placed within pixel boundaries. Like the nonlinear transfer function(s) 214 of FIG. 2, the nonlinear transfer function module(s) 310 of FIG. 3 may be varied, and can change depending upon the desired transfer function over a scan line (e.g., 226) of pixel data. Computations by nonlinear transfer functions are performed by execution of corresponding nonlinear transfer function modules 310 on processor 302. In addition, the application algorithm module 308 is executable on processor 302 to compute transformed widths of the pixel data from rasterizer module 306 based on a nonlinear transfer function 310. The application algorithm 308 applies the nonlinear transfer function 310 to the width values of the pixel data such that nonlinear transfer function 310 computes the transformed widths of pixels. Application algorithm 308 generates streams of video data based on the transformed pixel widths and the placement parameters (i.e., center justified; right justified; left justified; and inverted center justified) encoded into the pixel data from rasterizer 306.

Exemplary Methods

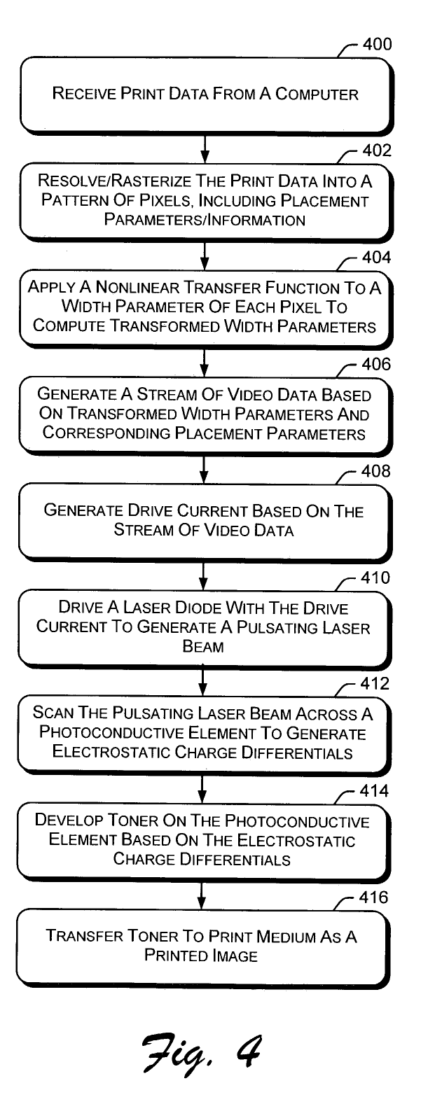

An example method for using an embodiment of an electrophotographic imaging device such as described above will now be described with primary reference to the flow diagram of FIG. 4. The method applies generally to the exemplary embodiments discussed above with respect to FIGS. 1-3. The elements of the described method may be performed by any appropriate means including, for example, by hardware logic blocks on an ASIC or by the execution of processor-readable instructions defined on a processor-readable media, such as a disk, a ROM or other such memory device.

A “processor-readable medium,” as used herein, can be any means that can contain, store, communicate, propagate, or transport such instructions for use by or in connection with an imaging system or imaging apparatus. The processor-readable medium can be, without limitation, an electronic, magnetic, optical, electromagnetic, infrared, or semiconductor system, apparatus, device, or propagation medium. More specific examples of a processor-readable medium include, among others, an electrical connection (electronic) having one or more wires, a portable computer diskette (magnetic), a random access memory (RAM) (magnetic), a read-only memory (ROM) (magnetic), an erasable programmable-read-only memory (EPROM or Flash memory), an optical fiber (optical), and a portable compact disc read-only memory (CDROM) (optical). Note that the processor-readable medium could even be paper or another suitable medium upon which the program may be printed, as the program can be electronically captured, via for instance optical scanning of the paper or other medium, then compiled, interpreted or otherwise processed in a suitable manner if necessary, and then stored in a memory.

Referring to the method illustrated in FIG. 4, at block 400, an electrophotographic imaging device receives print data from a computer. At block 402, the imaging device rasterizes the data or resolves it into a pattern of pixels. The pixel data is encoded with placement parameters (center justified; right justified; left justified; and inverted center justified) that indicate how subpixel modulations are to be placed within pixel boundaries. At block 404, a nonlinear transfer function is applied to a width parameter for each pixel in order to compute transformed pixel widths. At block 406, a stream of video data is generated based on the transformed pixel widths and corresponding placement parameters. At block 408, a drive current is generated based on the stream of video data.

The method continues at block 410, where the drive current is used to drive a laser diode. The laser diode generates a pulsating laser beam whose pulses have a time period that correspond to the time period of the pulses of the stream of video data. At block 412, the pulsating laser beam is scanned across a photoconductive element such as a drum or belt. The scanning generates regions of electrostatic charge differentials that form a latent image across the surface of the photoconductive element. At block 414, toner is developed onto the photoconductive element based on the pattern of the latent image formed by the electrostatic charge differentials. At block 416, the toner is transferred from the photoconductive element to a print medium as a printed image.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

Additionally, while one or more methods have been disclosed by means of flow diagrams and text associated with the blocks of the flow diagrams, it is to be understood that the blocks do not necessarily have to be performed in the order in which they were presented, and that an alternative order may result in similar advantages.

1. A processor-readable medium comprising processor-executable instructions configured for:
resolving print data into pixels that each have a corresponding placement parameter;
applying a nonlinear transfer function to a width parameter of each of the pixels to compute transformed width parameters; and
generating data based on the transformed width parameters and corresponding placement parameters.

2. A processor-readable medium as recited in claim 1, comprising further processor-executable instructions configured for:
generating a pulsating laser beam from the data;
scanning the pulsating laser beam across a photoconductive element to generate electrostatic charge differentials on the photoconductive element;
developing toner on the photoconductive element based on the electrostatic charge differentials; and
transferring the toner onto a print medium as a printed image.

3. A processor-readable medium as recited in claim 1, wherein the corresponding placement parameter is selected from the group comprising:
a left justification;
a right justification;
a center justification; and
an inverted center justification.

4. A processor-readable medium comprising processor-executable instructions configured for:
receiving print data from a computer;
rasterizing the print data into a pattern of pixels, each pixel in the pattern of pixels including a corresponding placement parameter;
for each pixel in the pattern of pixels, computing a transformed width parameter;
generating drive current based on transformed width parameters and corresponding placement parameters.

5. A processor-readable medium as recited in claim 4, wherein the computing a transformed width parameter further comprises applying a nonlinear transfer function to the pattern of pixels.

6. A processor-readable medium as recited in claim 4, comprising further processor-executable instructions configured for:
driving a laser diode with the drive current to generate a pulsating laser beam; and
scanning the pulsating laser beam across a photoconductive element to generate electrostatic charge differentials on the photoconductive element.

7. A processor-readable medium as recited in claim 6, comprising further processor-executable instructions configured for:
developing toner on the photoconductive element based on the electrostatic charge differentials; and
transferring the toner onto a print medium as a printed image.

8. A processor-readable medium as recited in claim 4, wherein the corresponding placement parameter is selected from the group comprising:
a left justification;
a right justification;
a center justification; and
an inverted center justification.

9. A system comprising:
rasterizing circuitry configured to receive print data and resolve the print data into pixels and placement information;
transformation circuitry configured to perform a nonlinear transformation;
an application algorithm circuit configured to apply the nonlinear transformation to a width parameter for each pixel and to compute transformed width parameters; and
pulse width modulation circuitry configured to accept the transformed width parameters and the placement information and to generate drive current based on the transformed width parameters and the placement information.

10. A system as recited in claim 9, further comprising:
a laser diode configured to receive the drive current and generate a pulsating laser beam according to the drive current;
a scanning device configured to reflect the pulsating laser beam in a horizontal pattern across a photoconductive element, the reflected pulsating laser beam forming a latent image on the photoconductive element in the form of electrostatic charge differentials;
a developer configured to develop toner to the photoconductive element according to the electrostatic charge differentials; and
a transfer roller configured to transfer the toner to a print medium.

11. An ASIC (application specific integrated circuit) comprising hardware blocks configured for:
resolving print data into pixels that each have a corresponding placement parameter;
applying a nonlinear transfer function to a width parameter of each of the pixels to compute transformed width parameters; and
generating video data based on the transformed width parameters and corresponding placement parameters.

12. An ASIC (application specific integrated circuit) comprising hardware blocks configured for:
receiving print data from a computer;
rasterizing the print data into pixels, each pixel including a corresponding placement parameter;
generating a transformed width parameter for each pixel by applying a nonlinear transfer function;
generating drive current based on transformed width parameters and corresponding placement parameters.

13. An ASIC (application specific integrated circuit) comprising:
rasterizing circuitry configured to receive print data and resolve the print data into pixels and placement information;
transformation circuitry configured to perform a nonlinear transform;
an algorithm circuit configured to compute transformed pixel widths using the nonlinear transform and to generate video data based on the transformed pixel widths and the placement information; and
pulse width modulation circuitry configured to generate drive current based on the video data.

14. An ASIC as recited in claim 13, wherein the placement information comprises parameters selected from the group comprising:
a left justification;
a right justification;
a center justification; and
an inverted center justification.

15. An electrophotographic imaging device comprising:
a rasterizer configured to generate pixel data, including placement information, from print data;
a nonlinear transfer function;
an application algorithm configured to compute transformed pixel width parameters using the nonlinear transfer function and to generate data based on the transformed pixel width parameters and the placement information; and
a pulse width modulator configured to generate drive current based on the data.

16. An electrophotographic imaging device as recited in claim 15, wherein the rasterizer, the nonlinear transfer function, and the application algorithm, are software modules executable on a processor.

17. An electrophotographic imaging device as recited in claim 15, wherein the rasterizer, the nonlinear transfer function, and the application algorithm, are blocks of logic on an ASIC (application specific integrated circuit).

18. An electrophotographic imaging device as recited in claim 15, wherein the electrophotographic imaging device is selected from a group comprising:
a printer;
a copier;
a scanner;
a fax machine; and
a multifunction peripheral device.

19. A method comprising: N resolving print data into pixels, each pixel having a corresponding placement parameter;
applying a nonlinear transformation to a width parameter of each pixel; and
generating drive current based on transformed width parameters and corresponding placement parameters.

20. A method of rendering video data for a laser at a variable frequency, the method comprising:
receiving print data from a computer;
rasterizing the print data into a pattern of pixels, each pixel in the pattern of pixels including a corresponding placement parameter;
for each pixel in the pattern of pixels, generating a transformed width parameter by applying a nonlinear transformation to the pattern of pixels;
generating drive current based on transformed width parameters and corresponding placement parameters.

21. An imaging device comprising:
means for resolving print data into pixels that each have a corresponding placement parameter;
means for transforming pixel widths with a nonlinear transfer function; and
means for generating video data based on transformed pixel widths and corresponding placement parameters.

22. An imaging device as recited in claim 21, further comprising:
means for generating a pulsating laser beam from the video data;
means for scanning the pulsating laser beam across a photoconductive element to generate electrostatic charge differentials on the photoconductive element;
means for developing toner on the photoconductive element based on the electrostatic charge differentials; and
means for transferring the toner onto a print medium as a printed image.

23. An imaging device comprising:
means for rasterizing print data into pixels, each pixel having a corresponding placement parameter;
means for computing a transformed width parameter for each pixel; and
means for generating video data from transformed pixel widths and corresponding placement parameters.

24. An imaging device as recited in claim 23, wherein the means for computing a transformed width parameter further comprises means for applying a nonlinear transfer function to the pixels.

25. An imaging device as recited in claim 23, wherein the corresponding placement parameter is selected from the group comprising:
a left justification;
a right justification;
a center justification; and
an inverted center justification.
